(19) United States
(12) Patent Application Publication
(10) Pub. No.: US 2026/0134072 A1
(43) Pub. Date: May 14, 2026

(54) Authenticated Spatial Gesture Recognition

(71) Applicant: International Business Machines Corporation, Armonk, NY (US)

(72) Inventors: Danny Soroker, Larchmont, NY (US); Zvonimir Fras, Markham (CA); Kaushal Savani, Surat (IN); Rhythm Thakur, Hoshiarpur (IN)

(21) Appl. No.: 18/940,980

(22) Filed: Nov. 8, 2024

(51) Int. Cl. G06F 21/32; G06F 3/01; G06V 10/82; G06V 40/20; G06V 40/30

(52) U.S. Cl. CPC G06F 21/32; G06F 3/017; G06V 10/82; G06V 40/28; G06V 40/394

(57) ABSTRACT

A method performs an action in a computer system. A set of gestures performed by a specific user is detected. A determination is made as to whether the set of gestures is performed by the specific user for the action using a machine learning model system. The action is performed in the computer system in response to detecting the set of gestures performed by the specific user. According to other illustrative embodiments, a computer system and a computer program product for performing an action in a computer system are provided.

### BACKGROUND

The disclosure relates generally to an improved gesture recognition system and more specifically to gesture recognition that recognizes gestures made by a specific user.

With the rapid development of personal computers, mobile devices, and virtual spaces, properly authenticating a user's identity to protect information and operations accessible through these devices is important. User authentication involves verifying the identity of a user attempting to access resources, such as applications, databases, or networks, to ensure that the user is authorized for the access. These resources can include secure resources such as financial records, confidential business information, bank accounts, and other types of resources.

The authentication process involves the user providing credentials, such as a password, biometric data, or a security token, which are compared against stored data to confirm their validity. Authentication methods can be single-factor or multi-factor. Once authenticated, the user is granted access to resources based on the permissions and roles of the user within the system.

### SUMMARY

According to one illustrative embodiment, a method performs an action in a computer system. A set of gestures performed by a specific user is detected. A determination is made as to whether the set of gestures is performed by the specific user for the action using a machine learning model system. The action is performed in the computer system in response to detecting the set of gestures performed by the specific user. According to other illustrative embodiments, a computer system and a computer program product for performing an action in a computer system are provided.

### BRIEF DESCRIPTION OF THE DRAWINGS

FIG. 1 is a block diagram of a computing environment in accordance with an illustrative embodiment;

FIG. 2 is a block diagram of a gesture environment in accordance with an illustrative embodiment;

FIG. 3 is an illustration of authenticated spatial gesture recognition in accordance with an illustrative embodiment;

FIG. 4 is a flowchart of a process for performing an action in a computer system in accordance with an illustrative embodiment;

FIG. 5 is a flowchart of a process for determining whether the set of gestures is performed by a specific user for an action in accordance with an illustrative embodiment;

FIG. 6 is a flowchart of a process for training a machine learning model in accordance with an illustrative embodiment;

FIG. 7 is a flowchart of a process for training a machine learning model in accordance with an illustrative embodiment;

FIG. 8 is a flowchart of a process for training a machine learning model to recognize gestures in the form of handwriting in accordance with an illustrative embodiment; and

FIG. 9 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

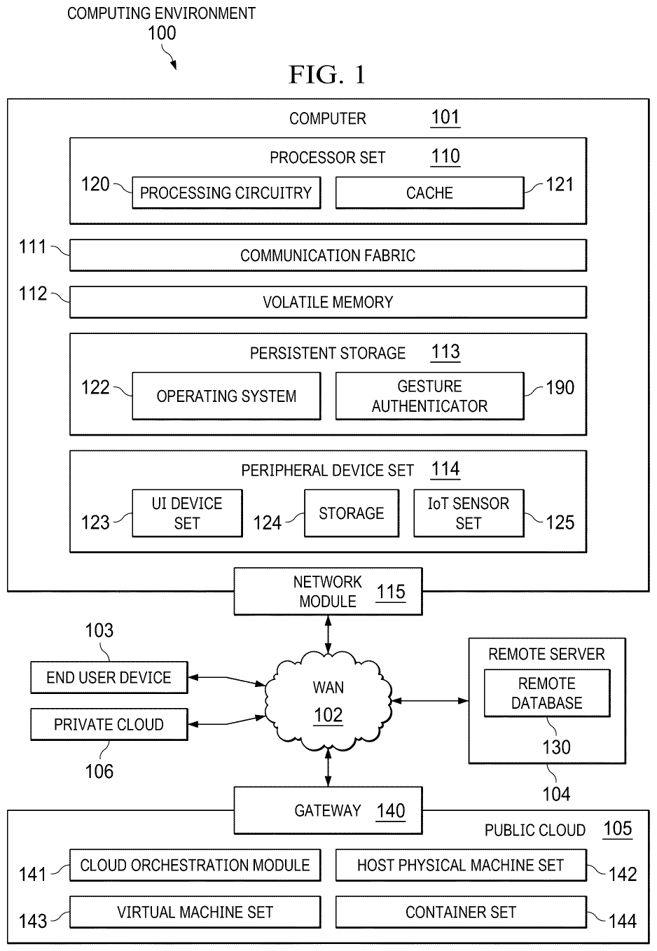

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as gesture authenticator 190. In addition to gesture authenticator 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and gesture authenticator 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in gesture authenticator 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in gesture authenticator 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. Current techniques can authenticate a user to operate the device such as a computer. However, once the user is authenticated, nothing prevents another user from performing actions at the computer if the current session is still in place. It is desirable to authenticate actions performed by user in a computer system. With the use of authenticating a user for a particular action rather than authenticating user to operated device and increase the amount of security.

In the illustrative examples, a gesture formed by the user is detected by a computer system. This gesture is authenticated as being performed by the user for a particular action rather than just access to a particular resource. In other words, the authentication is performed to ensure that the action requested is from a user that has rights or privileges to perform that action.

Thus, the illustrative embodiments provide a method, apparatus, system, and computer program product for performing an action. In one illustrative example, a set of gestures performed by a specific user is detected in the computer system. A determination is made as to whether the set of gestures is performed by the specific user for the action using a machine learning model system. The action is performed in the computer system in response to detecting the set of gestures performed by the specific user.

As used herein, “a set of” when used with reference to items means one or more items. For example, a set of gestures is one or more gestures.

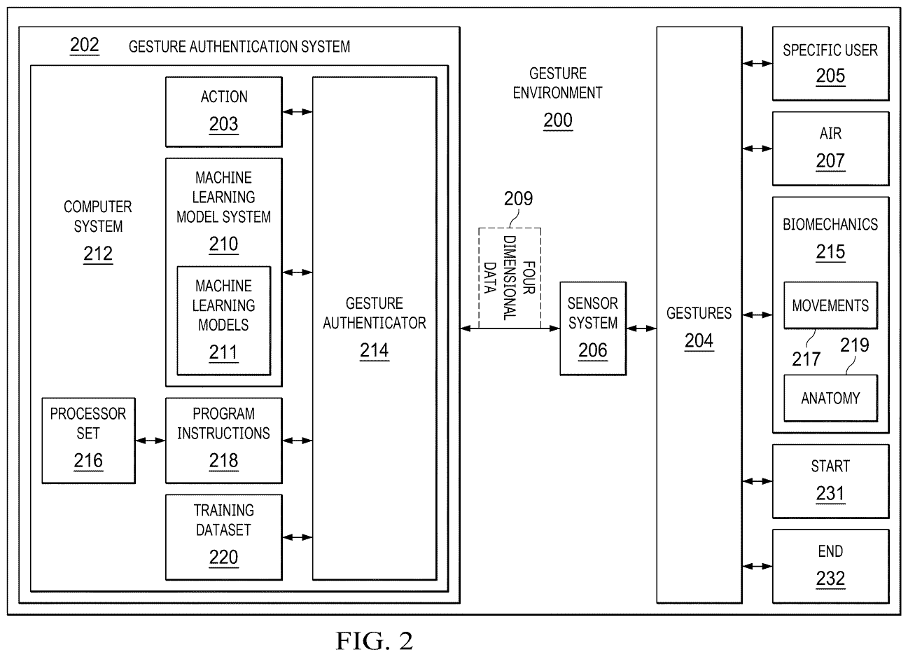

With reference now to FIG. 2, a block diagram of a gesture environment is depicted in accordance with an illustrative embodiment. In this illustrative example, gesture environment 200 includes components that can be implemented in hardware such as the hardware shown in computing environment 100 in FIG. 1. In this example, gesture authentication system 202 can operate to perform action 203 in computer system 212 in response to performance of a set of gestures 204 by specific user 205. Gesture authentication system 202 performs action 203 as part of authenticated gesture recognition.

In this example, authentication of the set of gestures 204 involves analyzing the set of gestures 204 to determine whether set of gestures 204 is performed by specific user 205. Further, the set of gestures 204 is also analyzed to determine what action to perform. In other words, a set of gestures are authenticated as being performed by specific user 205 and for a specific action, such as action 203.

In this illustrative example, a gesture is a movement of one or more parts of a body. The part can be a hand, a head, a finger, an arm, a foot, a knee, or some other body part. In this example, a set of gestures is detected by sensor system 206.

Sensor system 206 comprises one or more sensors that can be used to detect the set of gestures 204. For example, sensor system 206 can comprise at least one of a lidar sensor, a camera, a cyber glove, a motion sensing input device, a capacitive proximity sensor, a radar-based sensor, an optical motion capture system, and other suitable types of sensors that can detect the set of gestures 204.

Sensor system 206 generates four dimensional data 209. Four dimensional data 209 comprises the position of one or more body parts of specific user 205 in three dimensions and the movement of those body parts over time. This four dimensional data is sent to gesture authentication system 202 for use in determining whether specific user 205 has performed the set of gestures 204 for a specific action such as action 203.

In this example, the set of gestures is associated with action 203. Action 203 can be selected from a group comprising accessing a resource, starting a computer, shutting down a computer, starting a device, shutting down a device, opening a file, opening a folder in a file system, starting a scan, performing a backup, sending a message, initiating a financial transaction, signing a document, and other suitable actions.

Gesture authentication system 202 comprises a number of different components. As depicted, this system comprises computer system 212 and gesture authenticator 214. Gesture authenticator 214 may be implemented using gesture authenticator 190 in FIG. 1.

Gesture authenticator 214 can be implemented in software, hardware, firmware or a combination thereof. When software is used, the operations performed by gesture authenticator 214 can be implemented in program instructions configured to run on hardware, such as a processor unit. When firmware is used, the operations performed by gesture authenticator 214 can be implemented in program instructions and data can be stored in persistent memory to run on a processor unit. When hardware is employed, the hardware can include circuits that operate to perform the operations in gesture authenticator 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units that can be implemented using processor set 110 in FIG. 1. The processor units can also be referred to as computer processors. When processor set 216 executes program instructions 218 for a process, processor set 216 can be one or more processor units that are in the same computer or in different computers. In other words, the process can be distributed between processor units in processor set 216 on the same or different computers in computer system 212.

Further, processor set 216 can include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

Gesture authenticator 214 operates to perform action 203 in computer system 212 using authenticated spatial gestion recognition. For example, gesture authenticator 214 detects a set of gestures 204 performed by specific user 205. In this example, set of gestures 204 is detected using sensor system 206.

In one example, gesture authenticator 214 detects start 231 and end 232 of a set of gestures 204. Start 231 and end 232 can be detected in a number of different ways. For example, the start 231 of a set of gestures 204 can be identified by a number of different actions performed by specific user 205.

For example, specific user 205 can position fingers as if specific user 205 is holding a pen or stylus. In another example, specific user 205 can turn the palms of the hands to face sensor system 206. In yet another example, the hands of specific user 205 can be placed in a specific location. These and other types of actions by specific user 205 can be used to indicate the beginning of the set of gestures 204.

End 232 of the set of gestures 204 can be identified in a number of different ways. For example, a time window can be used to determine when data collected for the set of gestures 204 has been completed. The end of the time window defines end 232 for the set of gestures 204. In another example, specific user 205 positions a hand in a specific location to indicate end 232 of the set of gestures 204.

Further, in this illustrative example, a set of gestures 204 are performed in air 207. For example, specific user 205 moves one or more body parts in free space. This movement can be performed without interacting with a surface or object such as a tablet or other device. In this manner, specific user 205 can perform the set of gestures 204 through natural movements and without predefined movements on a tablet or other surface. For example, specific user 205 can hold fingers as if specific user 205 is holding a pen and can move the hand in a manner to write letters that are detected by sensor system 206.

Gesture authenticator 214 determines whether the set of gestures 204 is performed by specific user 205 for action 203 using machine learning model system 210. In this example, machine learning model system 210 comprises a set of machine learning models 211.

The set of machine learning models 211 in machine learning model system 210 can be one or more machine learning models of the same or different types depending on the particular implementation. Machine learning model system 210 can be comprised of at least one of a neural network, a convolutional neural network, a recurrent neural network, a random forest, a support vector machine, a large language model, a transformer mode, or some other suitable model that can be used to detect a set of gestures 204.

In determining whether the set of gestures 204 are performed by specific user 205 for action 203, gesture authenticator 214 can determine whether biomechanics 215 for the set of gestures 204 are for specific user 205 for action 203 using machine learning model system 210. In this example, biomechanics 215 comprises at least one of anatomy 219 or movements 217 of specific user 205.

In this illustrative example, anatomy 219 is the physical structure of the human body and in this example is specific to specific user 205 and can be distinguished from other users. For example, biomechanics can include the positions of joints in the body of specific user 205. For example, three-dimensional points can be assigned to positions of joints in the fingers, wrist, arm, and other parts of the body of specific user 205. In another example, anatomy 219 can be at least one of a size or shape of a palm, a finger, an arm, a wrist, or other body part of specific user 205.

Further in this example, movements 217 is the manner in which specific user 205 moves a number of body parts. This movement can include at least one of a three-dimensional trajectory, a velocity, acceleration, or other types of movement of anatomy 219 over time. For example, one user may have a different movement of a finger when writing a letter as compared to another user. In another example, drawing a shape such as a star or square has a different movement between different users.

In this illustrative example, gesture authenticator 214 performs action 203 in computer system 212 in response to detecting the set of gestures 204 performed by specific user 205.

In the illustrative example, machine learning model system 210 can be trained to detect a set of gestures 204 performed by specific user 205. In other words, machine learning model system 210 can distinguish the set of gestures 204 performed by specific user 205 as compared to another user by training the machine learning model system to recognize the set of gestures 204 performed by specific user 205 based on biomechanics 215 of specific user 205. For example, machine learning model system 210 can be trained to recognize the set of gestures 204 comprising anatomy 219 of specific user 205 and movements 217 of a number of body parts by specific user 205.

In one example, the set of gestures 204 comprises letters. With this example, machine learning model system 210 can be trained to recognize the handwriting of specific user 205 based on biomechanics 215 of specific user 205. When trained to recognize handwriting, action 203 can be a lexical item spelled out by specific user 205 performing the set of gestures 204. A lexical item is a unit of meaning in a language. This unit can be a single word or a group of words that function as a single unit.

In these illustrative examples, the training of machine learning model system, 210 can be performed using currently known training processes for machine learning models 211 in machine learning model system 210. The training can be performed by generating training dataset 220. For example, training dataset 220 can be generated by sensor system 206 detecting the performance of gestures 204 by specific user 205. The set of gestures 204 can be associated with action 203 to form training dataset 220, which can be used to train in machine learning model system 210.

Computer system 212 can be configured to perform at least one of the steps, operations, or actions described in the different illustrative examples using software, hardware, firmware or a combination thereof. As a result, computer system 212 operates as a special purpose computer system in which gesture authenticator 214 in computer system 212 enables authenticating gestures as being performed by a particular user. In these examples, a set of gestures is detected and analyzed to determine whether the set of gestures is performed by a particular user for a specific action. In other words, the set of gestures is both identified as being formed by a particular user and for a specific action. Thus, gesture authenticator 214 transforms computer system 212 into a special purpose computer system as compared to currently available general computer systems that do not have gesture authenticator 214.

In the illustrative example, the use of gesture authenticator 214 in computer system 212 integrates processes into a practical application for forming actions in a computer system. Formants in the computer system is increased by providing greater security and authenticating users to initiate actions in the computer system.

The illustration of gesture environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, gesture authentication system 202 can include sensor system 206. As another example, the set of gestures 204 can also initiate performance of one or more actions in addition to action 203. For example, a set of gestures 204 can initiate multiple actions such as starting an application and beginning a transaction. In another example, the set of gestures 204 can be used to open a database and begin a backup process.

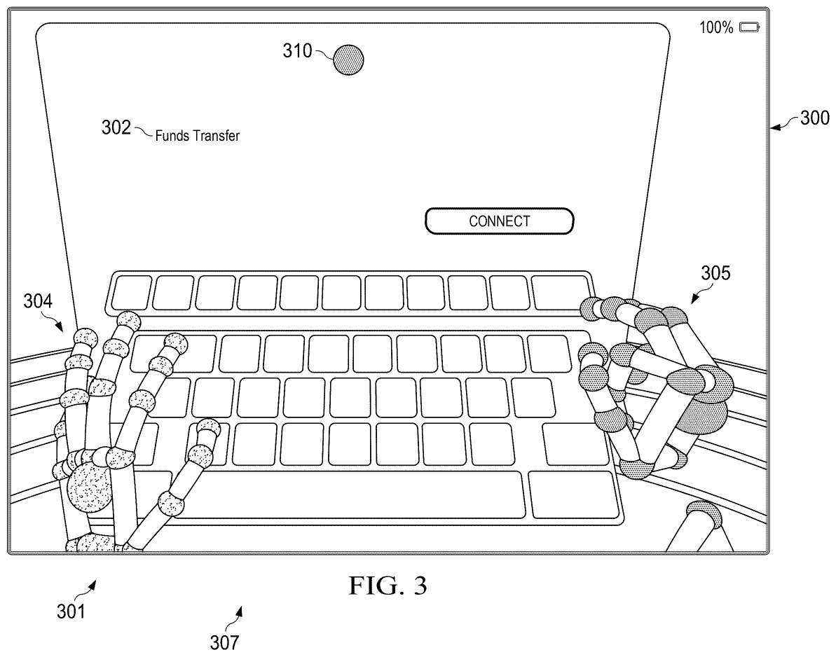

Turning next to FIG. 3, an illustration of authenticated spatial gesture recognition is depicted in accordance with an illustrative embodiment. In this altered example, laptop computer 300 is operated by user 301. Laptop computer 300 is an example of computer system 212 or a computing device in computer system 212 in FIG. 2. As depicted, laptop computer 300 has camera 310, which is an example of a sensor in sensor system 206 in FIG. 2.

In this example, user 301 desires to initiate an action in the form of funds transfer 302. To initiate funds transfer 302, user 301 performs a set of gestures using left-hand 304 and right hand 305 in hands 307.

Camera 310 collects four dimensional data. In this example, the four dimensional data comprises positions of joint in hands 307 over time. This four dimensional data can be in the form of a point cloud. Each point in this point cloud represents the location of a joint in left-hand 304 or right hand 305 at a point in time. This point cloud is an example of four dimensional data 209 in FIG. 2. Laptop computer 300 tracks the movement of these points over time to track hand movements. These hand movements includes speed and relative location of hands 307 to laptop computer 300.

In this example, the joints in hands 307 are the anatomy of these hands. These joints in hands 307 are unique from person to person. For example, the position of the joints varies from person to person depending on the length of their bones. Further, the size and shape of these joints in hands 307 can also vary from person to person.

Additionally, this point cloud provide data that can be used to track the movement of hands 307. Even if two people performed the same gesture, depending on their skills and habits, the movement of hands 307 are different in addition to differences in the anatomy. This anatomy and movements of hands 307 form biomechanics use in analyzing gestures performed by specific user 205.

In this example, a machine learning model system operating on laptop computer 300 has been trained to detect gestures performed by hands 307 of user 301 that are associated with performing funds transfer 302. Thus, when the gestures performed by user 301 identified as being performed by user 301 for funds transfer 302, the funds transfer is initiated. In these examples, user 301 performs other gestures that associate or cause the initiation of other actions such as opening an application, sending an email message, shutting down the computer, or other actions.

These different gestures and actions associated with the gestures can be detected by laptop computer 300 as having been performed by user 301 for the associated actions from training machine learning model system. Durning gesture learning, the machine learning system can receive four dimensional data from repeated performance of gestures for a particular action. The machine learning model system identifies variances in performing the gestures and can provide feedback to user 301 based on repeatability and complexity. For example, user 301 can then be instructed to provide more examples (by reproducing the gesture repeatedly, in different settings, or in different ways) or to choose a different gesture (in case the gestures used are not complex enough or the variance between the gestures are too high).

In selecting gestures for training, gestures can be selected based on a number of different factors. For example, gestures can be selected based on at least one of difficulty to perform, difficulty to remember, distinctness from other gestures, repeatability by the same user, or distinguishability between different users. One example is gestures based on handwriting. For example, lexical items spelled out by a user can be used. In other words, the user can use writing to spell words and phrases representing actions that are desired.

The illustration of user 301 performing gestures at laptop computer 300 to initiate funds transfer 302 is provided as one example and not meant to limit the manner in which other illustrative examples can be implemented. For example, in other illustrative examples, a user can perform gestures at a kiosk. A kiosk can be well suited for this type of process when these systems include cameras, three-dimensional sensors, and processing resources. This kiosk can be in a commercial environment or manufacturing environment.

In a commercial environment, the kiosk can be, for example, an automatic teller machine or a point-of-sale device. The user can perform gestures to receive funds from the automatic teller machine or complete a sale at the point-of-sale device.

In a manufacturing environment, the environment can be a harsh one such as a factory floor, a machine room, or a freezing location. The user can be at a kiosk in the form of a control system for manufacturing equipment. In this type of environment, it may be infeasible or impractical for the user to handle or touch controls. In this case, the user performs gestures to initiate actions. These actions can include starting a piece of equipment, halting a piece of equipment, ordering supplies, or other actions.

In some cases, the same gesture can initiate a different action depending on the context of the environment. For example, a gesture can be used to start a furnace that is idle in a manufacturing environment. The same gesture can be used to stop the furnace when the furnace is already operating. As a result, the same gesture can result in a different action depending on the context of the situation.

In another example, the context can be based on where the user is looking. If the user is looking at a first location, the first action can be initiated when performing a gesture. When the user looks at a second location, a different action can be initiated when performing the same gesture. In this manner, the number of gestures needed can be reduced with the use of context.

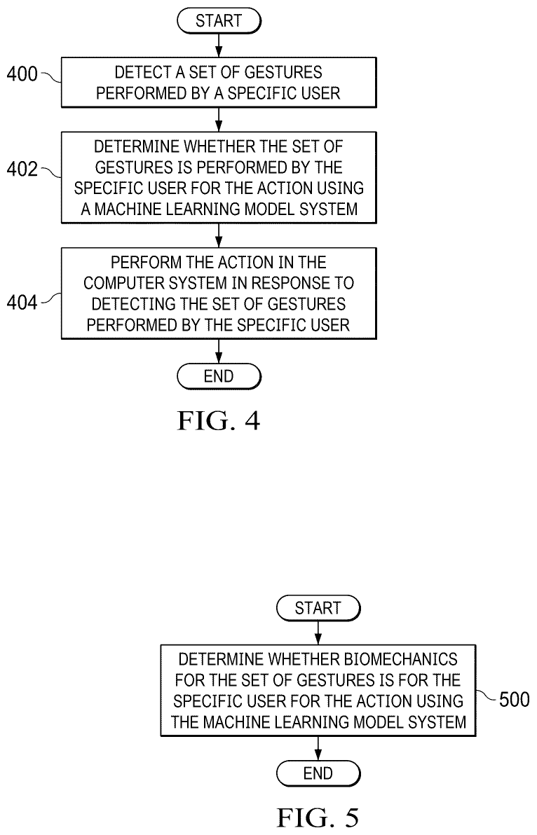

Turning next to FIG. 4, a flowchart of a process for performing an action in a computer system is depicted in accordance with an illustrative embodiment. This process involves authenticating a set of gestures performed by a user for a particular action. In other words, the process determines whether a set of gestures associated with an action is performed by a specific user. The process in FIG. 4 can be implemented in hardware, software, or both. When implemented in software, the process can take the form of program instructions that are run by a processor set located in one or more hardware devices in one or more computer systems. For example, the process can be implemented in gesture authenticator 214 in computer system 212 in FIG. 2.

The process detects a set of gestures performed by a specific user (step 400). The process determines whether the set of gestures is performed by the specific user for the action using a machine learning model system (step 402). The machine learning model system in step 402 comprises at least one of a neural network, a convolutional neural network, a recurrent neural network, a random forest, a support vector machine, a large language model, a transformer model, or some other suitable type of machine learning model that can be trained to process gestures. In step 402, the set of gestures can be performed in the air.

The process performs the action in the computer system in response to detecting the set of gestures performed by the specific user (step 404). The process terminates thereafter.

Turning now to FIG. 5, a flowchart of a process for determining whether the set of gestures is performed by a specific user for an action is depicted in accordance with an illustrative embodiment. The process in this flowchart is an example of an implementation for step 402 In FIG. 4.

The process determines whether biomechanics for the set of gestures is for the specific user for the action using the machine learning model system (step 500). The process terminates thereafter. In step 500, the biomechanics comprises at least one of an anatomy or movement of the specific user.

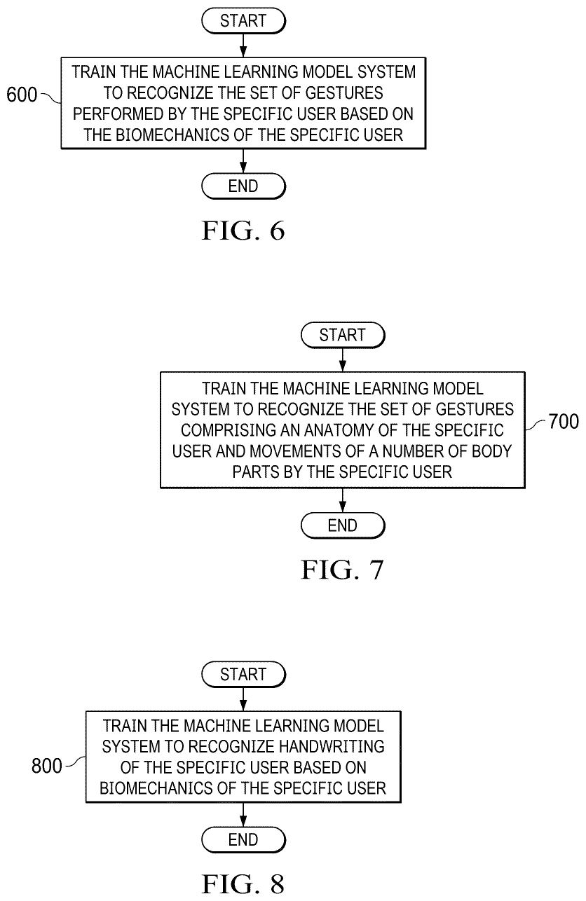

With reference next to FIG. 6, a flowchart of a process for training a machine learning model is depicted in accordance with an illustrative embodiment. The process in this figure is an example of an additional step that can be performed with the steps in FIG. 4 and FIG. 5 to process gestures.

The process trains the machine learning model system to recognize the set of gestures performed by the specific user based on the biomechanics of the specific user (step 600). The process terminates thereafter.

In FIG. 7, a flowchart of a process for training a machine learning model is depicted in accordance with an illustrative embodiment. The process in this figure is an example of an additional step that can be performed with the steps in FIG. 4.

The process trains the machine learning model system to recognize the set of gestures comprising an anatomy of the specific user and movements of a number of body parts by the specific user (step 700). The process terminates thereafter.

Turning to FIG. 8, a flowchart of a process for training a machine learning model to recognize gestures in the form of handwriting is depicted in accordance with an illustrative embodiment. The process in this figure is an example of a step that can be performed with the steps in FIG. 4. In this example, the set of gestures comprises letters.

The process trains the machine learning model system to recognize handwriting of the specific user based on biomechanics of the specific user (step 800). The process terminates thereafter.

In this illustrative example, the action is a lexical item spelled out by the specific user. The machine learning mode is trained to recognize the lexical items spelled out by the user in the handwriting of the user. As a result, the gestures forming the handwriting of the user for the lexical item is recognized as being formed by a particular user. Further, this lexical item can spell out the action that is to be performed. In this manner, the set of gestures performed by a user can be used to authenticate that the user is performing the set of gestures for a particular action.

For added security, the gesture may itself rely on a secret known to the user. In one illustrative example, the secret is a gesture that is the signature of the user. In another example, the secret is a lexical spelling of the user's password.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

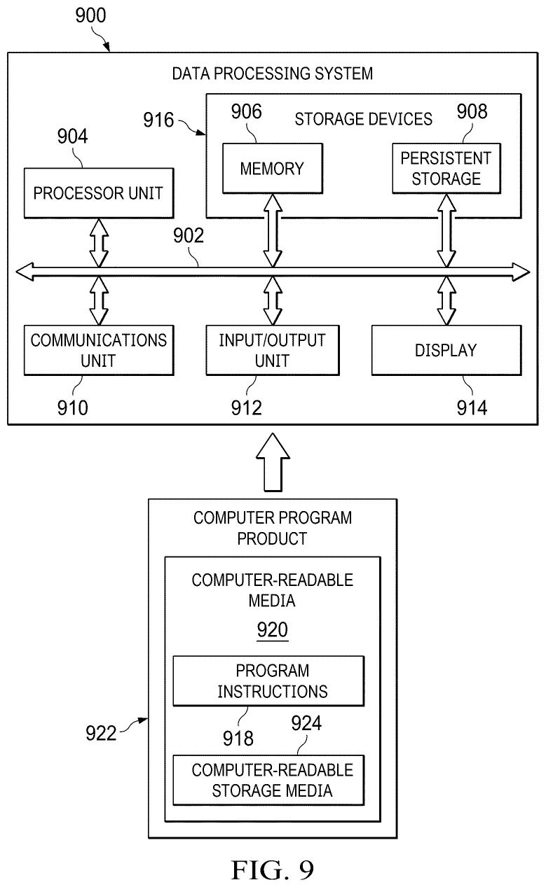

Turning now to FIG. 9, a block diagram of a data processing system is depicted in accordance with an illustrative embodiment. Data processing system 900 can be used to implement computers and computing devices in computing environment 100 in FIG. 1. Data processing system 900 can also be used to implement computer system 212 in FIG. 2. In this illustrative example, data processing system 900 includes communications framework 902, which provides communications between processor unit 904, memory 906, persistent storage 908, communications unit 910, input/output (I/O) unit 912, and display 914. In this example, communications framework 902 takes the form of a bus system.

Processor unit 904 serves to execute instructions for software that can be loaded into memory 906. Processor unit 904 includes one or more processors. For example, processor unit 904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 904 can be implemented using one or more heterogeneous processor systems in which a main processor is present with secondary processors on a single chip. As another illustrative example, processor unit 904 can be a symmetric multi-processor system containing multiple processors of the same type on a single chip.

Memory 906 and persistent storage 908 are examples of storage devices 916. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 916 may also be referred to as computer-readable storage devices in these illustrative examples. Memory 906, in these examples, can be, for example, a random-access memory or any other suitable volatile or non-volatile storage device. Persistent storage 908 may take various forms, depending on the particular implementation.

For example, persistent storage 908 may contain one or more components or devices. For example, persistent storage 908 can be a hard drive, a solid-state drive (SSD), a flash memory, a rewritable optical disk, a rewritable magnetic tape, or some combination of the above. The media used by persistent storage 908 also can be removable. For example, a removable hard drive can be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that can be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs can be located in storage devices 916, which are in communication with processor unit 904 through communications framework 902. The processes of the different embodiments can be performed by processor unit 904 using computer-implemented instructions, which may be located in a memory, such as memory 906.

These instructions are referred to as program instructions, computer usable program instructions, or computer-readable program instructions that can be read and executed by a processor in processor unit 904. The program instructions in the different embodiments can be embodied on different physical or computer-readable storage media, such as memory 906 or persistent storage 908.

Program instructions 918 are located in a functional form on computer-readable media 920 that is selectively removable and can be loaded onto or transferred to data processing system 900 for execution by processor unit 904. Program instructions 918 and computer-readable media 920 form computer program product 922 in these illustrative examples. In the illustrative example, computer-readable media 920 is computer-readable storage media 924.

Computer-readable storage media 924 is a physical or tangible storage device used to store program instructions 918 rather than a medium that propagates or transmits program instructions 918. Computer-readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 918 can be transferred to data processing system 900 using a computer-readable signal media. The computer-readable signal media are signals and can be, for example, a propagated data signal containing program instructions 918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 920” can be singular or plural. For example, program instructions 918 can be located in computer-readable media 920 in the form of a single storage device or system. In another example, program instructions 918 can be located in computer-readable media 920 that is distributed in multiple data processing systems. In other words, some instructions in program instructions 918 can be located in one data processing system while other instructions in program instructions 918 can be located in one data processing system. For example, a portion of program instructions 918 can be located in computer-readable media 920 in a server computer while another portion of program instructions 918 can be located in computer-readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of, another component. For example, memory 906, or portions thereof, may be incorporated in processor unit 904 in some illustrative examples. In other examples, more than one processor unit can be present. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program instructions 918.

Thus, illustrative embodiments of the present invention provide a computer implemented method, computer system, and computer program product for performing an action in a computer system. A set of gestures performed by a specific user is detected. A determination is made as to whether the set of gestures is performed by the specific user for the action using a machine learning model system. The action is performed in the computer system in response to detecting the set of gestures performed by the specific user.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

1. A method for performing an authenticated action in a computer system, the method comprising:
detecting a set of gestures performed by a specific user;
determining, using a machine learning model system, whether the set of gestures corresponds to the authenticated action and is performed by the specific user for the authenticated action; and
performing the authenticated action in the computer system in response to determining that the set of gestures corresponds to the authenticated action and is performed by the specific user for the authenticated action.

2. The method of claim 1, wherein the set of gestures is performed in air.

3. The method of claim 1, wherein determining comprises:
analyzing biomechanics of the specific user derived from four-dimensional data representing positions of one or more body parts of the specific user over time.

4. The method of claim 3, wherein the biomechanics comprises at least one of an anatomy or movement of the specific user.

5. The method of claim 3 further comprising:
training the machine learning model system to recognize the set of gestures performed by the specific user based on the biomechanics of the specific user.

6. The method of claim 1 further comprising:
training the machine learning model system to recognize the set of gestures comprising an anatomy of the specific user and movements of a number of body parts by the specific user.

7. The method of claim 1, wherein the set of gestures comprises
handwriting forming a lexical item corresponding to the authenticated action, and wherein determining includes analyzing biomechanics of the specific user associated with the handwriting.

8. The method of claim 7, wherein the action is a lexical item spelled out by the specific user.

9. The method of claim 1, wherein the set of gestures spells out at least one of a secret or a password.

10. The method of claim 1, wherein the set of gestures is a signature of the specific user.

11. The method of claim 1, wherein the machine learning model system comprises at least one of a neural network, a convolutional neural network, a recurrent neural network, a random forest, a support vector machine, a large language model, or a transformer model.

12. A computer system for performing an authenticated action comprising:
a processor set;
a set of one or more computer-readable storage media; and
program instructions, collectively stored in the set of one or more storage media to cause the processor set to perform operations comprising:
detecting a set of gestures performed by a specific user;
determining, using a machine learning model system, whether the set of gestures corresponds to the authenticated action and is performed by the specific user for the authenticated action; and
performing the authenticated action in the computer system in response to determining that the set of gestures corresponds to the authenticated action and is performed by the specific user for the authenticated action.

13. The computer system of claim 12, wherein the set of gestures is performed in air.

14. The computer system of claim 12, wherein determining comprises:
analyzing biomechanics of the specific user derived from four-dimensional data representing positions of one or more body parts of the specific user over time.

15. The computer system of claim 14, wherein the biomechanics comprises at least one of an anatomy or movement of the specific user.

16. The computer system of claim 14, wherein the operations further comprise:
training the machine learning model system to recognize the set of gestures performed by the specific user based on the biomechanics of the specific user.

17. The computer system of claim 12 wherein the operations further comprise:
training the machine learning model system to recognize the set of gestures comprising an anatomy of the specific user and movements of a number of body parts by the specific user.

18. The computer system of claim 12, wherein the set of gestures comprises letters and wherein the operations further comprise:
training the machine learning model system to recognize handwriting of the specific user based on biomechanics of the specific user.

19. A computer program product for performing an authenticated action in a computer system, the computer program product comprising:
a set of one or more computer-readable storage media;
program instructions stored on the set of one or more storage media to perform operations comprising:
detecting a set of gestures performed by a specific user;
determining, using a machine learning model system, whether the set of gestures corresponds to the authenticated action and is performed by the specific user for the authenticated action; and
performing the authenticated action in the computer system in response to determining that the set of gestures corresponds to the authenticated action and is performed by the specific user for the authenticated action.

20. The computer program product of claim 19, wherein the set of gestures is performed in air.
